(19) United States
(12) Patent Application Publication
(10) Pub. No.: US 2016/0059045 A1
(43) Pub. Date: Mar. 3, 2016

(54) Device for emergency evacuation from high-rise buildings and constructions

(71) Applicant: Sergey RASTOVTSEV, Zarafshan (UZ)

(72) Inventor: Sergey RASTOVTSEV, Zarafshan (UZ)

(21) Appl. No.: 14/674,082

(22) Filed: Mar. 31, 2015

Related U.S. Application Data
(60) Provisional application No. 62/085,703, filed on Dec. 1, 2014.

(30) Foreign Application Priority Data
Aug. 29, 2014 (UZ) IAP 20140363
Oct. 15, 2014 (KZ) 21289

(51) Int. Cl. A62B 1/20

(52) U.S. Cl. CPC A62B 1/20

(57) ABSTRACT

The invention relates to the means of rescue of lives in extreme situations of multi-storey buildings and constructions. The objective of the invention is to provide an efficient and reliable device designed to rescue lives in emergency situations of multi-storey buildings and constructions, to simplify, to reduce price, and to improve operational properties of the device by providing a safe and rapid evacuation from each floor of buildings and constructions. The concept of the invention is that the device makes it possible to evacuate from each floor of the building, consists of a trough fastened in the shaft, which is part of a building or facility, each level of which has access to the area located inside the shaft and sites are equipped with mats with straps and gloves.

REFERENCE TO RELATED APPLICATIONS

The present application claims priority to U.S. Provisional application No. 62/085,703 filed Dec. 1, 2014. It also claims priority to Uzbekistan Patent Application No. LAP 20140363 filed on Aug. 29, 2014 and Kazakhstan Patent Application Incoming No. 21289 filed on Oct. 15, 2014.

### BACKGROUND OF THE INVENTION

1. Field of the Invention

The invention is a device in the field of means to rescue lives in emergency situations. In particular this invention is in the field of rescuing people from high-rise buildings, garages, structures, and constructions in the event of fire or earthquake.

2. Background Art

One known method of emergency evacuation device implementation is shown in Pat. 2243014, Russia; Evacuation System From High-Rise Constructions. The method of evacuation is performed by sliding down the rescue tubular sleeve, stored in the form of a compact package, located on the top floor of the building. Packaging has a sleeve, consisting of sections made of sheet material extending around the periphery of a reinforced rigid support element, a tension cable, a means for selectively deploying and ejecting the sleeve along the first tension cable down to ground level, means for attachment of the first tension cable to a remotely located stationary object. The first tension cable stretched along the sleeve and extended freely along the sleeve on its upper generatrix through appropriate means, attached to support elements, and is the first tension cable is the only means for retaining the sleeve. Hooks are the means for the free passage of the tension cable. This technical solution provides a simple and reliable design of the tubular sleeve, wherein the tension cable is used as the sole means of retaining sleeves. The disadvantage of this method of emergency evacuation and device implementation is low reliability due to the fact that the tension cable is the only means for retaining the sleeve. Also, this invention is restricted to use in building no more than four or five stories tall as the evacuation from higher buildings requires the mount of the cable to be located at a considerable distance from the building (structure or construction), which in urban conditions this requirement is difficult to accommodate and perform.

Another known method and device for lifesaving is present in RU 2422174, c1. A62B 1/10 publ. 27, Jun. 2011. This method and device utilizes a safety rope with carabineer, a locking assembly in the form of a belt with a buckle, which places the stock tether connected to the sleeve, and a brake with the guide rollers located on the rope between a fixing assembly and snap. The disadvantages of this device are an inconvenience to use the mechanism of braking and complete failure with broken rope, building height restrictions, and as a consequence of the influence of external factors such as weather or fire or smoke spouting from the building.

Another known method and device for lifesaving incorporating a tubular spiral shaped design to evacuate each floor of a building individually, with no floors sharing the same spiral, is presented in the following application numbers: CN202506009U, EP2753401A1, WO2013034045A1 Rapid Escape Exit For High Building. This lifesaving design can be located either inside or outside the building. The disadvantages of this device is an enclosed space in the tube. While descending from a great height in a spiral there is a high possibility dizziness, lightheadedness, disorientation, and as a result, uncontrolled descent, which can lead to undesirable consequences. Also there is likely to be higher amount of g-forces involve in such a tight and tall spiral which could also have negative impacts.

The closest technical solution to the present invention is a “Means of Egress with Tall Buildings and Device for Carrying Out” Patent 2346716 issued Dec. 2, 2007g. That invention includes evacuation capsule adapted seats, seat belts and airbags, as well as a brake system to control the rate of descent. The evacuation capsule is transferred to the outer chute; the evacuation capsule is lowered into a trough located around the building (structure or construction), people seat themselves in the capsule. The descent is along the chute made of rails arranged at an angle to slide the capsule. The capsule is moving and of a streamlined shape. The disadvantages of this method are building that it is only well adapted to buildings of a specific shape such as round or oval; the size of the building is also limiting factor. In the case of installation on large buildings (structures or constructions), the angle of inclination of the trough may be insufficient for the capsule can descend itself, which requires the installation of an additional motor or mechanism for moving the capsule. In the case of increasing ramp angles, speed of descent of the capsule may be too great, which will be dangerous for people to descend into it. It is also a disadvantage of this method that the descent takes place in an open capsule, therefore, in the event of fire, open flame or smoke and all their negative effects will be experienced the people during the descent. Also, the weather conditions will affect the state of the guide, as they are outside and exposed to the elements. The disadvantage is also the high cost of maintenance of the device. Also there is a high probability of an accident during the descent, the collision capsules or congestion in the path of descent. There is a possibility of jamming the brake system.

### SUMMARY OF THE INVENTION

The object of the invention is to simplify, make cheaper, and improve the performance properties of the device, by providing a safe and rapid evacuation of each floor of buildings.

The proposed technical solution is a trough with a smooth gliding surface arranged in a spiral or serpentine pattern and fixed to a shaft forming part of a building or structure which may be any shape. This is a simple construction and allows for the device to be made cheaper. Each floor has access to a platform site located connected with the trough and shaft. At the trough there is a door that is designed to accommodate people moving from the platform site to the trough on each floor. This improves performance as it allows more people to evacuate from all floors of buildings, structures, or constructions simultaneously. Platform sites are equipped with seat mats and gloves instead of expensive capsules, which also simplifies and reduces the cost of the invention.

### BRIEF DESCRIPTION OF THE DRAWINGS

The present invention will now be discussed in further detail below with reference to the accompanying figures in which:

FIG. 1 is a depiction of a spiral shaped trough configuration.

FIG. 2 is a depiction of a serpentine shaped trough configuration.

FIG. 3 is a depiction of the complete device for emergency evacuation from high-rise buildings and constructions.

FIG. 4A depicts a flat bottomed trough design.

FIG. 4B depicts a cylindrical bottomed trough design.

FIG. 5 shows the complete device for emergency evacuation from high-rise buildings and constructions as part of a building.

### DETAILED DESCRIPTION OF THE PREFERRED EMBODIMENTS

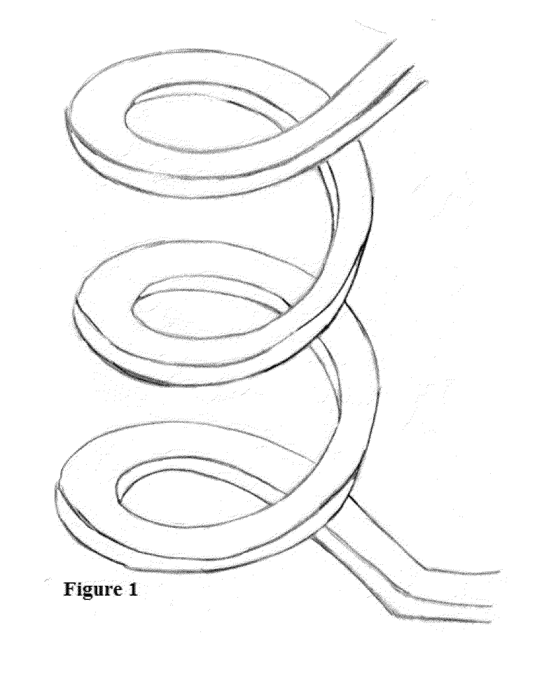

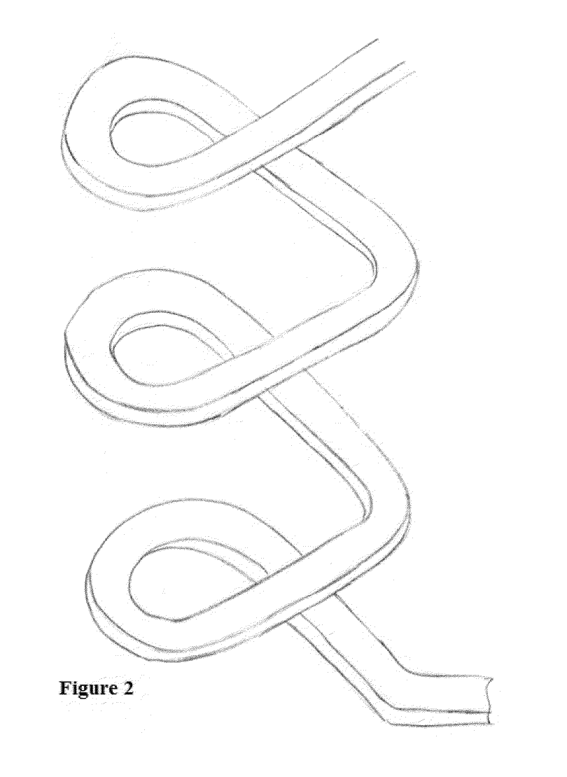

The proposed technical solution is a trough with a smooth gliding surface arranged in a spiral (FIG. 1) or serpentine (FIG. 2) pattern and fixed in a shaft housing structure 40 (FIG. 3) forming part of a building or structure which may be any shape.

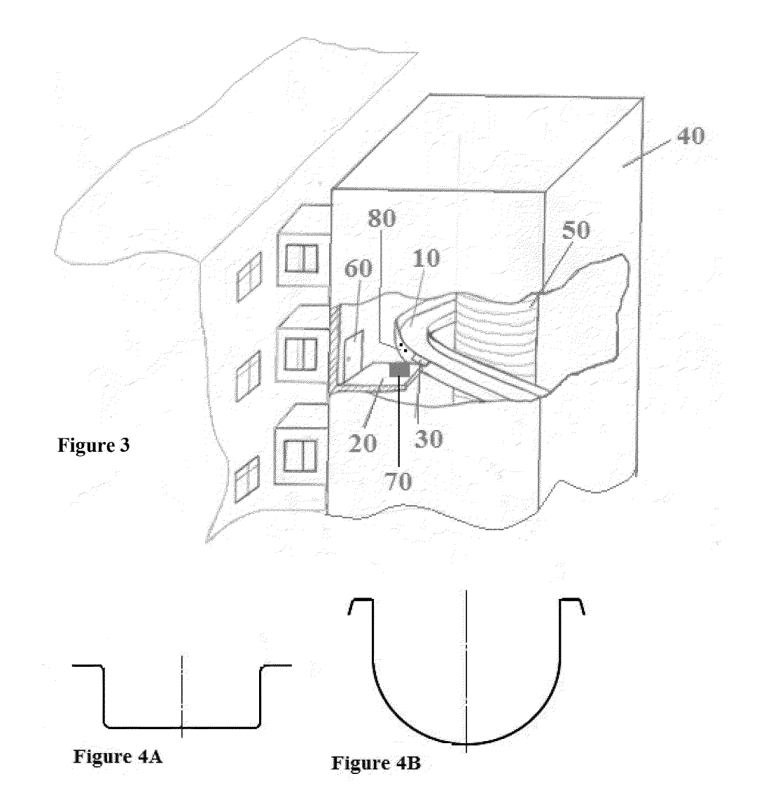

Discussing FIG. 3, trough 10 is located at an angle to the horizontal and arranged in a spiral, as demonstrated in FIG. 1, or serpentine, as demonstrated in FIG. 2, pattern descending between floors. The trough in cross-section can be formed with a flat bottom (FIG. 4A) or with a cylindrical bottom (FIG. 4B). The trough is located in a shaft housing structure 40 of circular or rectangular cross section made of refractory material, which can be located either inside or outside of a building, structure, or construction.

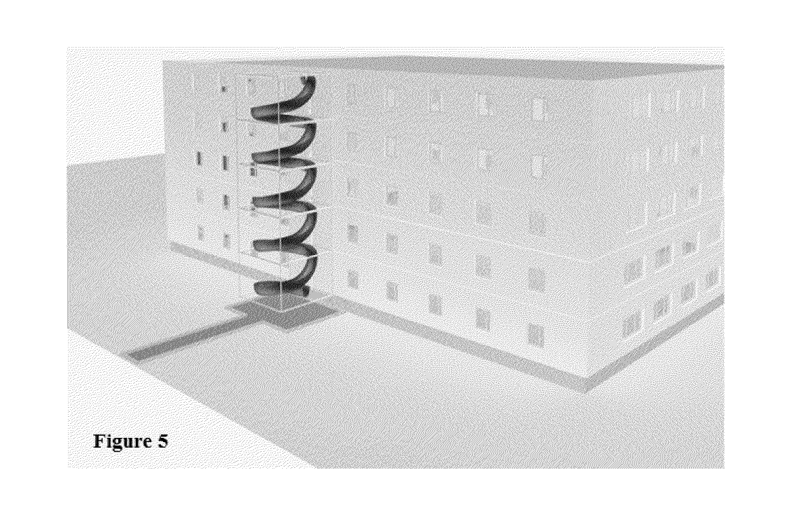

Each floor of the building, structure, or construction has access to the platform site 20, located inside the shaft housing structure 40. The trough 10 has doors 30 adjacent the platform site 20 so that people can enter the trough 10 at each platform site 20 on each floor. Platform sites 20 are equipped with seat mats and gloves 70 so that people evacuating can pick up the mats and gloves 70 before entering tough 10 on each floor. At the end of the trough's 10 descent to the exit area the trough 10 has a horizontal section (visible in FIG. 5), equipped with an L-shaped air bag (not shown), which performs the function of the brakes in the event of an uncontrolled descent with great speed and pushes the descending person to the side to make room for the next descending person.

Platform sites are equipped with special light signals 80 indicating whether it is possible to begin the descent: red signal indicating that someone should not enter trough 10; and green signal indicating it is safe to enter trough 10. This is an additional form of crowd control to increase safety and to prevent collisions or jams.

The trough 10 may be formed flat bottomed (FIG. 4A) or cylindrical bottomed (FIG. 4B). Shaft housing structure 40 may be located either inside or outside, or partially inside and partially outside, the building, structure, or construction.

The platform sites 20 should be provided with sufficient number of mats with eyelets for the legs and gloves for safe descent by the estimated number of occupants of a given floor.

The shaft housing structure 40 is equipped with a vertical perforated pipe 50 with a compressor or high-pressure fans in order to create positive displacement air pressure so as to prevent the shaft housing structure 40 from filling with smoke or other hazards to the people evacuating.

Access doors 60 for accessing the shaft housing structure are “compartment” type doors with a bias toward closure. Evacuation is made individually with people escaping out into the platform site 20, putting on the mat and gloves 70 and sitting in the trough 10 sliding down. If necessary individual sliding can use their gloved hand and their feet to slow descent. It is suggested that people who cannot walk or have other movement issues be accompanied by one or two people with at least one person up front who can help to control descent speed.

The advantages of the present invention is that it allows people to increase their safety during an evacuation event by being in an enclosed shaft housing structure 40 made of refractory material. The present invention is simpler and easier to use than the prior art and only requires the use of mats and gloves 70 while sitting in trough 10 and allowing gravity to propel the evacuee downward. The present invention is more reliable than the prior art because it does not require the use of any mechanical element that may cause binding or jams impeding an evacuation. The shaft housing structure also provides space for the storage of emergency vertical ladders and other fire-safety equipment. The present invention is more comfortable for evacuees because a person can slide in any comfortable position (standing, sitting, lying on their back, lying on their stomach, or holding onto each other).

Thus, the device of an emergency evacuation from high-rise buildings and structures allows for quick and safe evacuation of personnel that can be used to rescue people from a variety of multi storey buildings.

This device is made of conventional building materials, refractory bricks, plastic (GRP), metal, so is industrially applicable.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

1. A device for emergency evacuation from multi-storey buildings, structures, and constructions, comprising:
a. a shaft housing structure;
b. a trough affixed within the shaft housing structure;
c. the trough having a smooth sliding surface formed by a helix or streamers and affixed within the shaft housing structure;
d. wherein each floor of the multi-story building, structure, or construction has an access door;
e. wherein the access door leads to a platform site on each floor of the multi-story building, structure, or construction;
f. wherein each platform site has a door to the trough designed to fit people from the platform site into the trough on each floor;
g. and where the trough ends in a horizontal section at an exit zone equipped with an L-shaped air bag.

2. The device according to claim 1, wherein each platform site on each floor of the multi-storey building, structure, or construction is equipped with mats with foot straps and gloves.

3. The device according to claim 1, wherein the trough has a cylindrical bottom.

4. The device according to claim 1, wherein the trough has a flat bottom.

5. The device according to claim 1, wherein the shaft housing structure is located outside of the multi-story building, structure, or construction.

6. The device according to claim 1, wherein the shaft housing structure is located inside of the multi-story building, structure, or construction.

7. The device according to claim 1, wherein the shaft housing structure is located both partially inside and partially outside the multi-story.

8. The device according claim 1, wherein the shaft housing structure contains perforated vertical pipe fitted with a high-pressure compressor or fan for creating positive displacement air pressure over atmospheric pressure.
